(19) United States
(12) Patent Application Publication
(10) Pub. No.: US 2004/0185250 A1
(43) Pub. Date: Sep. 23, 2004

(54) Triclosan containing absorbable sutures with extended antimicrobial properties

(76) Inventor: Amy T. John, Raleigh, NC (US)

Correspondence Address: Amy John, 2308 Wakefield Plantation Dr., Raleigh, NC, 27614, US

(21) Appl. No.: 10/767,304

(22) Filed: Jan. 30, 2004

Related U.S. Application Data
(60) Provisional application No. 60/445,578, filed on Feb. 7, 2003.

(51) Int. Cl. B32B 3/00

(52) U.S. Cl. 428/364

(57) ABSTRACT

Triclosan containing absorbable antimicrobial sutures with extended antimicrobial properties were disclosed. Triclosan can be incorporated into the absorbable sutures by coating, soaking, soaking and coating of triclosan containing solutions or adding triclosan into absorbable polymers before they are processed into fibers.

### FIELD OF THE INVENTION

This invention relates to triclosan containing absorbable sutures with extended antimicrobial properties and desirable handling characteristics.

### BACKGROUND

Coating medical devices with pharmaceutical agents is well documented in the art. Such coated devices could theoretically provide means for locally delivering pharmaceutical or therapeutic agents at the site of medical intervention. For example, sutures coated with antibiotics can deliver these bioactive agents directly to implantation site, therefore, reducing the possibility of infection following the surgical intervention.

There are generally two methods of coating a medical device, such as absorbable sutures, with antimicrobial agents: 1) placing the medical device into a solution containing an antimicrobial agent until it is bound or soaked into the device as described in U.S. Pat. No. 3,987,797 and No. 4,024,871 and also in a recent patent application assigned to Ser. No. 20020055759; or 2) coating the device with a polymeric matrix containing antimicrobial agents. U.S. Pat. No. 5,378,540 describes compositions for coating a surgical suture with a biodegradable polycaprolactone polymer, optionally containing a pharmaceutical agent.

However, prior art methods of antimicrobial absorbable sutures have typically been limited with respect of the types antimicrobial agents incorporated into the devices or unsatisfactory effect of the coating on the performances of the devices coated or relatively short retention of antimicrobial activity. Accordingly, there remains a need in the art for compositions and methods for absorbable antimicrobial sutures with adequate antimicrobial activity and equally importantly, the coated devices maintain their desirable performance characteristics.

Triclosan is a widely used antimicrobial agent found in various household products and medical field. It is one of the most efficacious biocides against staphylococcus at extremely low levels. It has also been used successfully in treatment regimens to eliminate topical infections with methicillin-resistant bacteria. The susceptibility of the most common device-related pathogens combined with inherently low toxicity makes triclosan a favorable candidate for absorbable antimicrobial suture application.

### SUMMARY OF THE INVENTION

Absorbable sutures, having desirable antimicrobial properties and handling characteristics, are obtained by incorporating triclosan and proper coating of the devices.

### DESCRIPTION OF PREFERRED EMBODIMENTS

One aspect of the present invention is the compositions of absorbable antimicrobial sutures, comprising absorbable polymers, such as homopolymers or copolymers of glycolide, lactide, caprolactone, dioxanone or trimethylene carbonate, triclosan and also one or more fatty acid salts, such as stearic acid calcium or sodium salts or stearic acid esters and related salts. The antimicrobial agent is triclosan and the fatty acid salts, in the form of calcium or sodium salts or esters and related salts, are to provide desirable handling characteristics of the devices, especially in the wet environment of the surgical field.

Another aspect of the invention is the process of incorporating triclosan into the absorbable sutures by any or combinations of following methods: coating the absorbable sutures with a mixture comprising triclosan, which is either added into the coating mixture or incorporated into the coating carrier polymers, one or more absorbable carrier polymers with or without triclosan and one or more fatty acid salts, in the form of calcium or sodium salts or esters and related salts; or treating the absorbable sutures with a solution of triclosan, and then coating with a mixture comprising one or more absorbable carrier polymers and one or more fatty acid salts, in the form of calcium or sodium salts or esters and related salts, with or without triclosan; or formulating triclosan into the absorbable sutures by adding triclosan into the polymerization reaction or blending triclosan into the absorbable polymers, spinning and braiding and then coating with a mixture comprising one or more absorbable carrier polymers and one or more fatty acid salts, in the form of calcium or sodium salts or esters and related salts, with or without triclosan.

### EXAMPLE 1

Polysorb* absorbable suture (Lactomer 9-1, U. S. Surgical, Norwalk, Conn.), size 2/0, was coated with a mixture of equal parts of copolymers of glycolide and lactide and calcium stearate containing various levels of triclosan. The coated antimicrobial sutures were cut into 5 cm pieces and extracted with 0.85% saline and incubated at 37° for 24 hrs; 48 hrs and 72 hrs. The extracted sutures and the non-extracted ones were dried and then placed aseptically in sterile Petri dishes and challenged with 100 uL of inoculum containing 10⁵ colony-forming units (CFU) of S. aureus. Tryptic soy agar was poured into each dish and then incubated for 37° C. for 48 hrs. After incubation, the plates were examined for zones of inhibition measurements.

### EXAMPLE 2

Polysorb* absorbable suture (Lactomer 9-1, U. S. Surgical, Norwalk, Conn.), size 2/0, was treated with 2.0% solution of triclosan and then heated at 65° C. for 2 minutes. The triclosan-treated sutures were further coated with a mixture of equal parts of copolymers of glycolide and lactide and calcium stearate without or with various levels of triclosan. A similar extraction and zones of inhibition measurement method in Example 1 were used to compare antimicrobial activities. It was found that the treated sutures had longer antimicrobial activity retention than the simple triclosan coated sutures from saline extraction, indicating slower releasing profile of triclosan in the aqueous medium.

### EXAMPLE 3

Un-coated absorbable suture braids (Samyang Corporation, South Korea), size 2/0, were treated with a solution of 1.8% triclosan in methylene chloride and then dried. The triclosan treated sutures were further coated with a coating solution containing triclosan (1.8%). The control samples were only coated with the same coating solution containing triclosan. The triclosan-treated and then triclosan-coated sutures had longer antimicrobial activities than only triclosan-coated sutures.

### EXAMPLE 4

A batch of 5.0 kg of copolymer of 90% glycolide and 10% lactide is divided into two equal portions. The first portion is mixed under nitrogen with a solution of 1% triclosan and then heated at 65° C. under vacuum, resulting in a total 600 ppm triclosan in the polymer. The second portion is used as control. Both portions are spun into fibers under same conditions and the resulted fibers from both have similar physical properties.

What is claimed is:

1. Triclosan containing absorbable sutures exhibiting extended antimicrobial activity retention and desirable handling characteristics.

2. Absorbable sutures according to claim 1, by a process comprising coating with a mixture comprising triclosan which is either added into the coating mixture or incorporated into the coating carrier polymers, one or more absorbable carrier polymers with or without triclosan and one or more fatty acid salts or treating non-coated sutures with a solution of triclosan, and coating with a mixture comprising one or more absorbable carrier polymers and one or more fatty acid salts with or without triclosan.

3. Absorbable sutures according to claim 1 by a process comprising incorporating triclosan into the absorbable polymers, spinning, braiding, and coating with a mixture comprising one or more absorbable carrier polymers and one or more fatty acid salts with or without triclosan.
